(19) United States
(12) Patent Application Publication
(10) Pub. No.: US 2016/0285821 A1
(43) Pub. Date: Sep. 29, 2016

(54) METHOD AND APPARATUS FOR INTERNET ACCESS OPTIMIZATION

(71) Applicant: Huawei Technologies Co., Ltd., Shenzhen (CN)

(72) Inventor: Zhonghu ZHANG, Beijing (CN)

(21) Appl. No.: 15/179,694

(22) Filed: Jun. 10, 2016

Related U.S. Application Data
(63) Continuation of application No. PCT/CN2013/088993, filed on Dec. 10, 2013.

(51) Int. Cl. H04L 29/12; H04L 12/741

(52) U.S. Cl. CPC H04L 61/1505; H04L 61/304; H04L 45/74; H04L 61/2503

(57) ABSTRACT

Embodiments of the present disclosure disclose an apparatus and a method for web access optimization. A hostname in a web page is replaced with an IP address corresponding to the hostname, and when a user equipment subsequently requests a URL in the web page, the hostname of the URL has been replaced with the IP address, and the user equipment can access network resources on a corresponding host according to the IP address. Therefore, the user equipment does not need to initiate a DNS request, thereby reducing a web content access delay and optimizing web content access.

### CROSS-REFERENCE TO RELATED APPLICATION(S)

This application is a continuation of International Application No. PCT/CN2013/088993 filed Dec. 10, 2013, which is hereby incorporated by reference herein in its entirety.

### TECHNICAL FIELD

Embodiments of the present disclosure relate to the communications field and, more specifically, to a method and an apparatus for Internet access optimization.

### BACKGROUND

As stipulated in the Internet Protocol, a network resource in the web is uniquely identified by using a uniform resource locator (URL), which is generally a website address. The URL includes a hostname, where the hostname is generally a hostname of a domain name system of a server that stores resources. When initiating a web access request to a web server, a user equipment acquires a hostname from a target URL, and then sends a query request to a domain name system (DNS) server to acquire an IP address corresponding to the hostname, and uses the IP address to initiate Internet access to the web server.

Therefore, when a user equipment requests web access, and every time the user equipment requests a URL in a web page after receiving the web page returned from a web server, because a hostname is included in the URL, the user equipment further needs to initiate a DNS query request to a DNS server to request an IP address corresponding to the hostname of the URL in the web page, which inevitably leads to an increase in a web content transmission delay. Therefore, how to reduce a web content transmission delay and optimize web access when a user equipment accesses a URL in a web page is an urgent problem to be solved at present.

### SUMMARY

Embodiments of the present disclosure provide an apparatus and a method for web access optimization, which can reduce a web content transmission delay when a user equipment accesses network resources corresponding to a URL in a web page.

According to a first aspect, an apparatus for web access optimization is provided, including: a receiving module, configured to receive a web page sent by a web server; an acquiring module, configured to acquire an IP address corresponding to a hostname of a URL in the web page; a processing module, configured to replace the hostname of the URL in the web page with the IP address corresponding to the hostname; and a sending module, configured to send the web page that is obtained after the replacement to a user equipment, so that the user equipment accesses network resources on a host corresponding to the IP address of the URL in the web page that is obtained after the replacement.

With reference to the first aspect, in a first possible implementation manner, that the acquiring module is configured to acquire an IP address corresponding to a hostname of a URL in the web page specifically includes that: the acquiring module is configured to query, in a local database, the IP address corresponding to the hostname of the URL in the web page.

With reference to the first possible implementation manner of the first aspect, in a second possible implementation manner, the apparatus further includes: the sending module, further configured to, when the acquiring module fails to acquire, from the local database, the IP address corresponding to the hostname of the URL in the web page, send a domain name system (DNS) request to a DNS server, where the DNS request includes the hostname of the URL in the web page and is used to request the IP address corresponding to the hostname of the URL in the web page; the receiving module, further configured to receive the IP address that is corresponding to the hostname of the URL in the web page and sent by the DNS server; and the acquiring module, further configured to acquire the IP address that is corresponding to the hostname of the URL in the web page and received by the receiving module.

With reference to the first aspect, in a third possible implementation manner, the sending module is further configured to, before the acquiring module acquires the IP address corresponding to the hostname of the URL in the web page, send a DNS request to a DNS server, where the DNS request includes the hostname of the URL and is used to request the IP address corresponding to the hostname; the receiving module is further configured to receive the IP address that is corresponding to the hostname of the URL in the web page and sent by the DNS server; and then, that the acquiring module is configured to acquire the IP address corresponding to the hostname of the URL in the web page specifically includes that: the acquiring module is configured to acquire the IP address that is corresponding to the hostname of the URL in the web page and sent by the DNS server.

With reference to the first aspect, the first or second or third possible implementation manner of the first aspect, in a fourth possible implementation manner, the receiving module is further configured to receive request information for requesting a web page sent by the user equipment; the sending module is further configured to send the request information for requesting the web page to the web server; and the receiving module is specifically configured to, after the sending module sends the request information to the web server, receive the web page sent by the web server; or the receiving module is specifically configured to receive a web page pushed by the web server.

According to a second aspect, another apparatus for web access optimization is provided, including: a receiving module, configured to receive a web page sent by network side, where the web page is a web page that is obtained after the network side replaces a hostname of a uniform resource locator (URL) in the web page received from a web server with an Internet Protocol (IP) address corresponding to the hostname; and a sending module, configured to send an access request to request to access network resources on a host corresponding to the IP address of the URL in the web page that is obtained after the replacement.

According to a third aspect, a method for web access optimization is provided, including: receiving a web page sent by a web server; acquiring an Internet Protocol (IP) address corresponding to a hostname of a uniform resource locator (URL) in the web page; replacing the hostname of the URL in the web page with the IP address corresponding to the hostname; and sending the web page that is obtained after the replacement to a user equipment, so that the user equipment accesses network resources on a host corresponding to the IP address of the URL in the web page that is obtained after the replacement.

With reference to the third aspect, in a first possible implementation manner, the acquiring an IP address corresponding to a hostname of a URL in the web page includes: querying a database according to the hostname of the URL in the web page, and acquiring, from the database, the IP address corresponding to the hostname of the URL in the web page.

With reference to the first possible implementation manner of the third aspect, in a second possible implementation manner, when the IP address corresponding to the hostname of the URL in the web page fails to be acquired, a domain name system (DNS) request is sent to a DNS server, where the DNS request includes the hostname, for which the IP address fails to be found, in the URL and is used to request the IP address corresponding to the hostname of the URL in the web page; and the IP address that is corresponding to the hostname of the URL in the web page and sent by the DNS server is acquired.

With reference to the third aspect, in a third possible implementation manner, the acquiring an IP address corresponding to a hostname of a URL in the web page includes: sending a DNS request to a DNS server; where the DNS request includes the hostname of the URL in the web page and is used to request the IP address corresponding to the hostname; and acquiring the IP address that is corresponding to the hostname of the URL in the web page and sent by the DNS server.

With reference to the third aspect, the first or second or third possible implementation manner of the third aspect, the receiving a web page sent by a web server includes: acquiring request information for requesting a web page sent by the user equipment; sending the request information to the web server; and receiving the web page sent by the web server; or receiving a web page pushed by the web server.

According to a fourth aspect, another method for web access optimization is provided, including: receiving, by a user equipment, a web page sent by a network side, where the web page is a web page that is obtained after the network side replaces a hostname of a uniform resource locator (URL) in a web page received from a web server with an Internet Protocol (IP) address corresponding to the hostname; and accessing, by the user equipment, network resources on a host corresponding to the IP address of the URL in the web page that is obtained after the replacement.

Based on the foregoing technical solutions, in an apparatus and a method for web access optimization provided in embodiments of the present disclosure, a web page sent by a web server is received; an IP address corresponding to a hostname in the web page is acquired; and the hostname in the web page is replaced with the IP address corresponding to the hostname, and the web page that is obtained after the replacement is sent to a user equipment. When the user equipment subsequently requests a URL in the web page, the hostname of the URL has been replaced with the IP address, and the user equipment can access network resources on a corresponding host according to the IP address. Therefore, the user equipment does not need to initiate a DNS request, thereby reducing a web content access delay and optimizing web content access.

### BRIEF DESCRIPTION OF DRAWINGS

To describe the technical solutions in the embodiments of the present disclosure more clearly, the following briefly introduces the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 shows a diagram of a network architecture on which embodiments of the present disclosure are based;

FIG. 2 shows a schematic block diagram of an apparatus 200 for web access optimization according to an embodiment of the present disclosure;

FIG. 3 shows a schematic block diagram of another apparatus 300 for web access optimization according to an embodiment of the present disclosure;

FIG. 4 shows a schematic flowchart of a method for web access optimization according to an embodiment of the present disclosure;

FIG. 5 shows a schematic flowchart of another method for web access optimization according to an embodiment of the present disclosure;

FIG. 6 shows a signaling interworking diagram of a method for web access optimization according to an embodiment of the present disclosure;

FIG. 7 shows a signaling interworking diagram of another method for web access optimization according to an embodiment of the present disclosure;

FIG. 8 shows a schematic block diagram of an apparatus 800 for web access optimization according to an embodiment of the present disclosure; and

FIG. 9 shows a schematic block diagram of another apparatus 900 for web access optimization according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are a part rather than all of the embodiments of the present disclosure. All other embodiments obtained by a person of ordinary skill in the art based on the embodiments of the present disclosure without creative efforts shall fall within the protection scope of the present disclosure.

It should be understood that, the technical solutions of the embodiments of the present disclosure may be applied to various communications systems, such as: a Global System of Mobile Communications (GSM) system, a Code Division Multiple Access (CDMA) system, a Wideband Code Division Multiple Access (WCDMA) system, a general packet radio service (GPRS), a Long Term Evolution (LTE) system, an LTE frequency division duplex (FDD) system, an LTE time division duplex (TDD), a Universal Mobile Telecommunications System (UMTS), a Worldwide Interoperability for Microwave Access (WiMAX) communications system or the like.

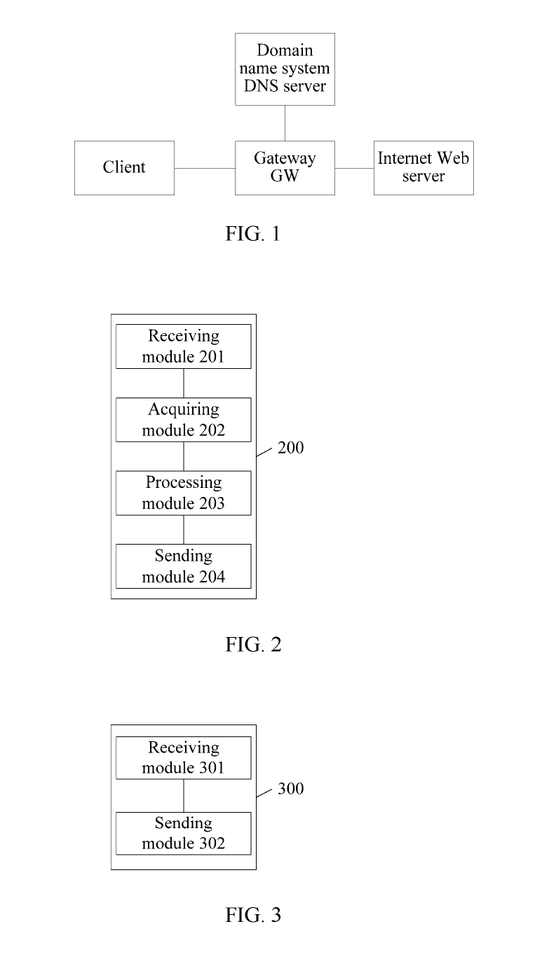

FIG. 1 shows a diagram of a network architecture on which embodiments of the present disclosure are based. The embodiments of the present disclosure may be further based on another network architecture, which is not limited in the embodiments of the present disclosure.

As shown in FIG. 1, in a network architecture that includes a user equipment, a gateway device (GW), a DNS server, and a web server, the GW mainly provides data conversion and data transmission between multiple networks; the DNS server mainly stores a correspondence between a domain name and an IP address.

In the embodiments of the present disclosure, the user equipment may be a terminal device that initiates an Internet access request, and may also be program software, such as a browser, which provides a service for a user. The GW may further provide a DNS proxy function, that is, provide a correspondence between an IP address and a hostname. In the embodiments of the present disclosure, the GW has a function of replacing a hostname of a URL in a received web page with an IP address corresponding to the hostname, and the function may also be implemented by an existing fixed-line access gateway, a mobile gateway, a web cache device, a content optimization device, an online compression device, or the like. An apparatus, a method, and a system for Internet access optimization that are provided in the embodiments of the present disclosure may be used with the prior art in an overlapped manner.

FIG. 2 shows a schematic block diagram of an apparatus 200 for web access optimization according to an embodiment of the present disclosure. This embodiment of the present disclosure may be executed by any proper apparatus, such as a gateway device, which is not limited in the present disclosure.

As shown in FIG. 2, the apparatus for web access optimization according to this embodiment of the present disclosure includes: a receiving module 201, an acquiring module 202, a processing module 203, and a sending module 204.

The receiving module 201 is configured to receive a web page sent by a web server.

The acquiring module 202 is configured to acquire an Internet Protocol (IP) address corresponding to a hostname of a uniform resource locator (URL) in the web page.

The web page includes a URL, that is, website address information. The apparatus acquires the hostname of the URL in the web page, so as to acquire, according to the hostname, the IP address corresponding to the hostname, where each hostname has a corresponding IP address.

In this embodiment of the present disclosure and other embodiments of the present disclosure, there is one hostname of a URL in a web page.

The processing module 203 is configured to replace the hostname of the URL in the web page with the IP address corresponding to the hostname.

The sending module 204 is configured to send the web page that is obtained after the replacement to a user equipment, so that the user equipment accesses network resources on a host corresponding to the IP address of the URL in the web page that is obtained after the replacement.

Therefore, based on an apparatus provided in this embodiment of the present disclosure, an IP address corresponding to a hostname in a web page is acquired, the hostname in the web page is replaced with a corresponding IP address, and the web page that is obtained after the replacement is sent to a user equipment. When the user equipment subsequently requests network resources corresponding to a URL in a received web page, because the hostname of the URL has been replaced with the IP address corresponding to the hostname, the user equipment does not need to initiate a query request to a DNS server, and can directly access, according to the IP address, network resources on a host corresponding to the IP address, thereby reducing a web content transmission delay and optimizing web access.

In another embodiment of the present disclosure, that the acquiring module 202 is configured to acquire an IP address corresponding to a hostname in the web page specifically includes that: the acquiring module 202 is specifically configured to query a database according to a hostname of a URL in the web page, and acquire, from the database, the IP address corresponding to the hostname of the URL in the web page. The database may be a database of the apparatus itself, and may also be a database externally connected to the apparatus, which is not limited in the present disclosure. The apparatus stores, in the database, IP addresses corresponding to a part of hostnames, and therefore, the processing module in the apparatus replaces the hostname of the URL in the web page with an IP address that is corresponding to the hostname and found from the database. Because the hostname of the URL in the web page has been replaced with the IP address corresponding to the hostname, when the user equipment requests again network resources corresponding to the hostname of the URL in the web page, the user equipment does not need to send a DNS request to acquire the IP address corresponding to the hostname from the DNS server, thereby reducing a web content transmission delay and optimizing web access.

In still another embodiment of the present disclosure, the apparatus further includes: the sending module 204, further configured to, when the acquiring module fails to acquire the IP address corresponding to the hostname of the URL in the web page, send a DNS request to the DNS server, where the DNS request includes the hostname of the URL and is used to request the IP address corresponding to the hostname of the URL in the web page; and the receiving module 201, further configured to receive the IP address that is corresponding to the hostname of the URL in the web page and sent by the DNS server. Therefore, when the user equipment subsequently requests network resources of the hostname of the URL in the web page, the user equipment does not need to send the DNS request to the DNS server to request to acquire the IP address corresponding to the hostname because the hostname of the URL in the web page has been replaced with the IP address corresponding to the hostname, thereby reducing a web content transmission delay and optimizing web access.

In another embodiment of the present disclosure, the sending module 204 is further configured to, before the acquiring module 202 acquires the IP address corresponding to the hostname of the URL in the web page, send a DNS request to the DNS server, where the DNS request includes the hostname of the URL and is used to request the IP address corresponding to the hostname; and then, that the acquiring module 202 is configured to acquire the IP address corresponding to the hostname of the URL in the web page specifically includes that: the acquiring module is configured to acquire the IP address that is corresponding to the hostname of the URL in the web page and sent by the DNS server. After acquiring the web page, the apparatus sends the DNS request that includes the hostname of the URL in the web page to the DNS server, so as to acquire the IP address corresponding to the hostname, and then replace the hostname of the URL in the web page according to the IP address corresponding to the hostname. Therefore, when the user equipment subsequently requests network resources of the hostname of the URL in the web page, the user equipment does not need to send the DNS request to the DNS server to request to acquire the IP address corresponding to the hostname because the hostname of the URL in the web page has been replaced with the IP address corresponding to the hostname, thereby reducing a web content transmission delay and optimizing web access.

In still another embodiment of the present disclosure, the receiving module 201 is further configured to receive request information for requesting a web page sent by a user equipment; the sending module 204 is further configured to send the request information for requesting the web page to a web server; the receiving module 201 is specifically configured to, after the sending module sends the request information to the web server, receive the web page sent by the web server; or the receiving module 201 is specifically configured to receive a web page pushed by the web server. The situations in which the apparatus receives the web page include: the sending module in the apparatus sends the request information for requesting a web page to the web server; the receiving module in the apparatus receives a web page pushed by the web server, for example, a collection of daily news regularly pushed by some portal websites.

In this embodiment of the present disclosure, there is one URL in content of the web page. When there are multiple URLs in the content of the web page, reference may be made to a processing manner in this embodiment in which there is one URL. That is, when there are multiple URLs in the content of the web page, for a processing manner of a hostname of each URL, refer to the processing manner in this embodiment of the present disclosure.

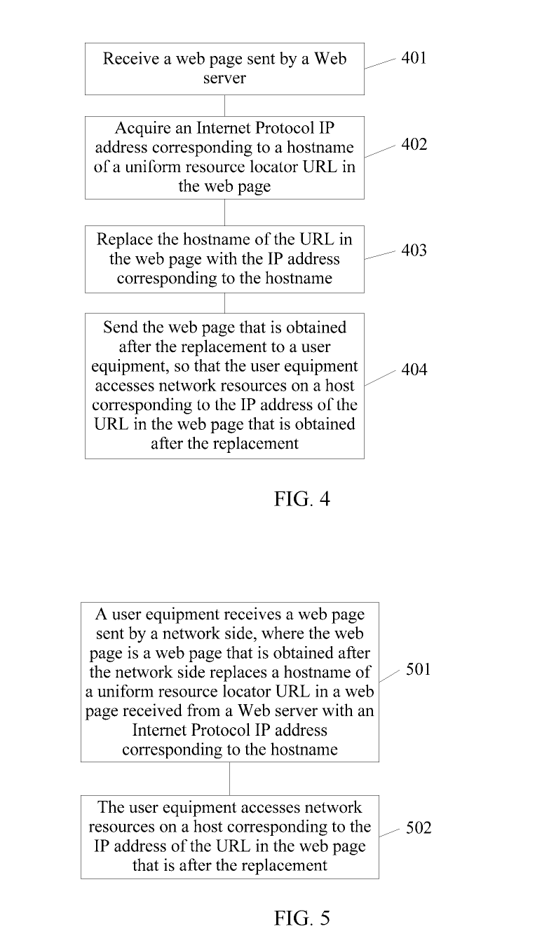

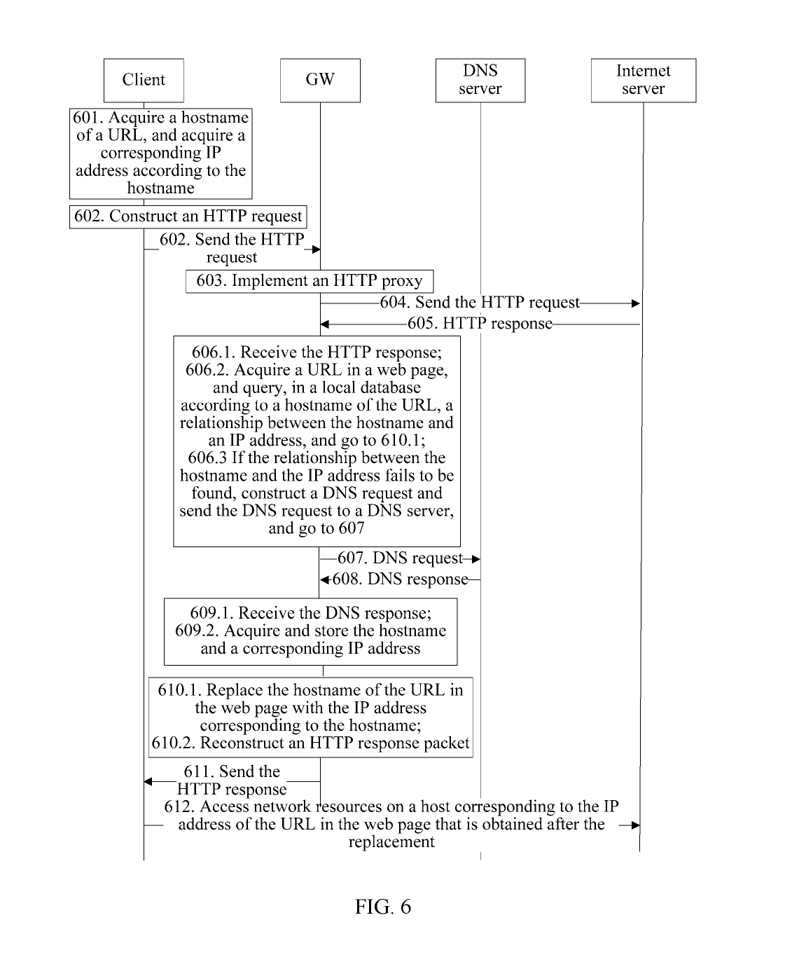

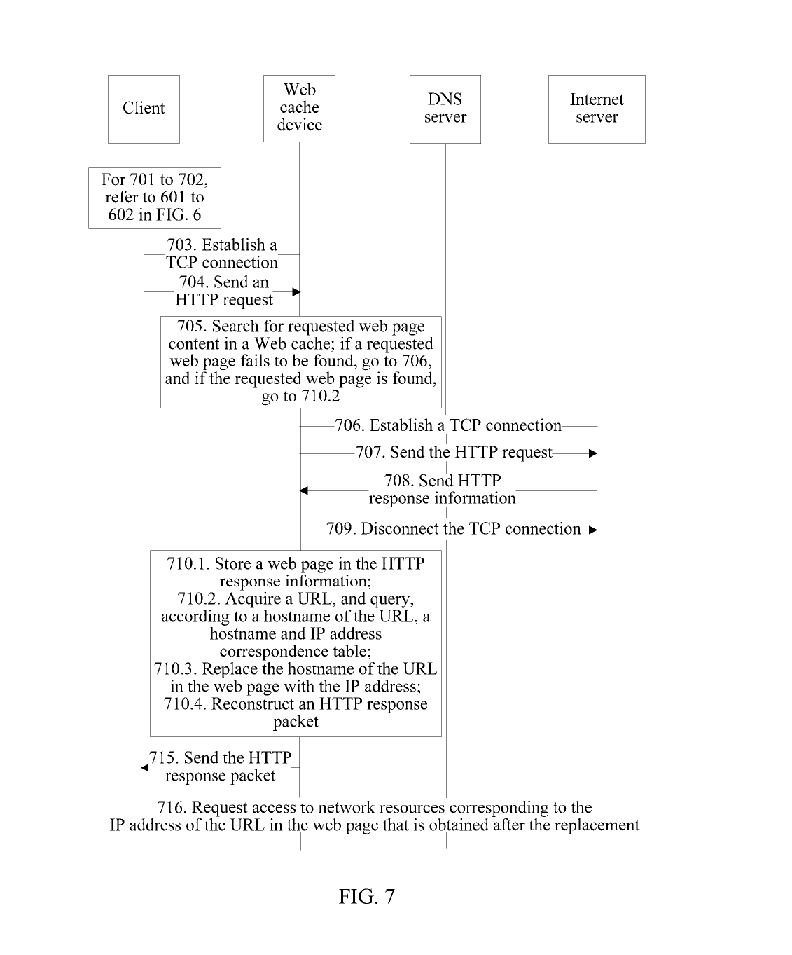

The apparatus 200 for Internet access optimization according to this embodiment of the present disclosure may correspond to an apparatus in a method for Internet access optimization in the following embodiments of the present disclosure, and the foregoing and other operations and/or functions of each module in the apparatus 200 for Internet access optimization in this embodiment of the present disclosure are separately used to implement corresponding processes of each method in FIG. 4, FIG. 6, and FIG. 7. For brevity, the details are not described herein again.

FIG. 3 shows a schematic block diagram of an apparatus 300 for web access optimization according to an embodiment of the present disclosure. The apparatus provided in this embodiment of the present disclosure may be any proper apparatus, for example, a user equipment. The apparatus provided in this embodiment of the present disclosure may be used together with the apparatus that is provided in the embodiment of the present disclosure and shown in FIG. 2.

A receiving module 301 is configured to receive a web page sent by a network side, where the web page is a web page that is obtained after the network side replaces a hostname of a uniform resource locator (URL) in a web page received from a web server with an Internet Protocol (IP) address corresponding to the hostname.

A sending module 302 is configured to send an access request for access to network resources on a host corresponding to the IP address of the URL in the web page after the replacement.

Therefore, based on an apparatus provided in this embodiment of the present disclosure, the apparatus receives a web page that is obtained after replacement. Because a hostname of a URL in the web page has been replaced with an IP address corresponding to the hostname, when the apparatus requests access to network resources corresponding to the URL, the apparatus does not need to send a DNS request to a DNS server, and can directly access, according to the IP address, the network resources on a host corresponding to the IP address, thereby reducing a web content transmission delay and optimizing web access.

The apparatus 300 for Internet access optimization according to this embodiment of the present disclosure may correspond to an apparatus in a method for Internet access optimization in the following embodiments of the present disclosure, and the foregoing and other operations and/or functions of each module in the apparatus 300 for Internet access optimization in this embodiment of the present disclosure are separately used to implement corresponding processes of each method in FIG. 5, FIG. 6, and FIG. 7; for brevity, details are not described herein again.

FIG. 4 shows a schematic flowchart of a method for web access optimization according to an embodiment of the present disclosure. The method provided in this embodiment of the present disclosure may be executed by any proper apparatus, and may be implemented by a gateway device, a fixed-line access gateway, a mobile gateway, a web cache device, a content optimization device, an online compression device, or the like, which is not limited in the present disclosure. The method provided in this embodiment of the present disclosure may be executed by the apparatus shown in FIG. 2.

As shown in FIG. 4, the method for web access optimization provided in this embodiment of the present disclosure includes:

S401. Receive a web page sent by a web server.

The receiving a web page sent by a web server in S401 may specifically include:

1. Acquire request information for requesting a web page sent by a user equipment, send the request information to the web server, and receive the web page sent by the web server; or

2. Receive a web page pushed by the web server.

The received web page pushed by the web server includes a URL. Generally, the URL is a website address link corresponding to other network resources. For example, a search web page is received, where the web page includes a link to web page resources on another website.

S402. Acquire an IP address corresponding to a hostname of a URL in the web page.

The 402 specifically includes: querying, in a database, the IP addresses corresponding to the hostnames of the URLs in the web page. After that, the hostnames in the web page are replaced with the IP addresses that are corresponding to the hostnames and found from the database. Because some hostnames of the URLs in the web page have been replaced with IP addresses corresponding to the hostnames, when the user equipment subsequently requests network resources of the hostnames, which are replaced, of the URLs in the web page, the user equipment does not need to send a DNS request to a DNS server, and can directly access, according to the IP addresses, network resources on hosts corresponding to the IP addresses, thereby reducing a web content transmission delay and optimizing web access.

In another embodiment of the present disclosure, the S402 may further include: when the IP address corresponding to the hostname of the URL in the web page fails to be found from the database, sending the DNS request to the DNS server, where the DNS request includes the hostname of the URL in the web page and is used to request the IP address corresponding to the hostname of the URL in the web page; then, acquiring and storing the IP address that is corresponding to the hostname of the URL in the web page and sent by the DNS server; and replacing the hostname of the URL in the web page with the IP address corresponding to the hostname. Therefore, when the user equipment subsequently requests network resources of the URL in the web page, the user equipment does not need to send the DNS request to the DNS server to request to acquire the IP address corresponding to the hostname, and can directly access, according to the IP address, network resources on a host corresponding to the IP address because the hostname of the URL in the web page has been replaced with the IP address corresponding to the hostname, thereby reducing a web content transmission delay and optimizing web access.

In still another embodiment of the present disclosure, the S402 specifically includes: sending the DNS request to the DNS server, where the DNS request includes the hostname of the URL in the web page and is used to request the IP address corresponding to the hostname; and acquiring the IP address that is corresponding to the hostname of the URL in the web page and sent by the DNS server. That is, after the web page is received, the request is sent to the DNS server, so as to request the IP address corresponding to the hostname of the URL in the web page, and then the hostname of the URL in the web page is replaced with the IP address corresponding to the hostname. Therefore, when the user equipment subsequently requests network resources of the URL in the web page, the user equipment does not need to send the DNS request to the DNS server to request to acquire the IP address corresponding to the hostname, and can directly access, according to the IP address, network resources on a host corresponding to the IP address because the hostname of the URL in the web page has been replaced with the IP address corresponding to the hostname, thereby reducing a web content transmission delay and optimizing web access.

S403. Replace the hostname of the URL in the web page with the IP address corresponding to the hostname.

S404. Send the web page that is obtained after the replacement to a user equipment, so that the user equipment accesses network resources on a host corresponding to the IP address of the URL in the web page that is obtained after the replacement.

FIG. 5 shows another method for web access optimization according to an embodiment of the present disclosure. The method may be executed by any proper apparatus, for example, a user equipment. The method shown in FIG. 5 may be used together with the method shown in FIG. 4.

As shown in FIG. 5, the method for web access optimization provided in this embodiment of the present disclosure includes:

S501. A user equipment receives a web page sent by a network side, where the web page is a web page that is obtained after the network side replaces a hostname of a uniform resource locator (URL) in a web page received from a web server with an Internet Protocol (IP) address corresponding to the hostname.

S502. The user equipment accesses network resources on a host corresponding to the IP address of the URL in the web page that is obtained after the replacement.

Therefore, based on a method provided in this embodiment of the present disclosure, when a user equipment accesses a URL of a web page that is obtained after replacement, because a hostname of the URL in the web page has been replaced with an IP address corresponding to the hostname, the user equipment does not need to send a DNS request to a DNS server to acquire the IP address corresponding to the hostname, and can directly access, according to the IP address, network resources on a host corresponding to the IP address, thereby reducing a web content transmission delay and optimizing web access.

FIG. 6 shows a signaling interworking diagram of a method for web access optimization according to an embodiment of the present disclosure. The method provided in this embodiment of the present disclosure may be executed by any proper apparatus, and a GW and a user equipment are used as an example for description in this embodiment. This embodiment of the present disclosure is a specific embodiment of embodiments of the present disclosure that are shown in FIG. 4 and FIG. 5.

As shown in FIG. 6, the method for web access optimization provided in this embodiment of the present disclosure includes:

S601. A user equipment acquires a hostname of a URL input by a user, and acquires, according to the hostname, an IP address corresponding to the hostname.

The URL is a website address input by the user. Generally, the user may input a home page address of a search website or a portal website address.

The user equipment may query, in a local DNS cache, the IP address corresponding to the hostname, where the local DNS cache is the IP address that is corresponding to the hostname of the URL accessed before and stored by the user equipment:

If the user equipment finds, in the local DNS cache, the IP address corresponding to the hostname, go to step 602 directly;

if the user equipment fails to find, in the local DNS cache, the IP address corresponding to the hostname, the user equipment sends a DNS request to a DNS server to query the IP address corresponding to the hostname; the user equipment receives DNS response information returned by the DNS server through a GW, where the DNS response information carries the hostname and the IP address corresponding to the hostname; and after that, there comes step 602. Optionally, when the DNS server sends the DNS response information to the user equipment by using the GW, the GW may intercept the DNS response information, acquire the hostname and the IP address corresponding to the hostname in the DNS response information, and store, in a database, the hostname and the IP address corresponding to the hostname.

S602. The user equipment constructs an HTTP (Hypertext Transfer Protocol) request and sends the HTTP request to a web server to request a web page.

The user equipment constructs the HTTP request according to the acquired IP address corresponding to the hostname.

S603. The GW processes, in an HTTP proxy manner, the HTTP request sent by the user equipment to the web server.

S604. The GW sends the HTTP request, which has been processed in the HTTP proxy manner, to the web server to request the web page that the user equipment expects to acquire.

S605. The web server sends HTTP response information to the GW.

The response message includes the web page requested by the user equipment.

S606.1. The GW receives the HTTP response information sent by the web server, and acquires the web page included in the response information.

In another embodiment of the present disclosure, a user equipment does not need to initiate a request, and a web server pushes a web page to the user equipment, for example, some portal websites actively send web pages with hot news of the day to the user equipment; and the GW intercepts the web page pushed by the web server. Then steps S601 to S605 may be omitted, and step S606.1 is replaced with that: The GW may receive the web page pushed by the web server, and after that, go to S606.2.

S606.2. The GW acquires a URL in the web page, queries the database, according to the hostname of the URL, to acquire the IP address corresponding to the hostname, and goes to S610.1.

Generally, many correspondences between hostnames and IP addresses are stored in the GW. In another embodiment of the present disclosure, because a GW may acquire a correspondence between a hostname and an IP address from DNS response information, when many correspondences between hostnames and IP addresses are stored in the GW, the GW may query, from the database, the IP address corresponding to the hostname. After that, S610.1 is performed, and in the embodiment, the GW itself does not need to send a DNS request to a DNS server either. Comparatively speaking, a web content access delay is further reduced, and user experience is improved.

S606.3. If there is a hostname for which an IP address fails to be found, construct a DNS request and perform a query on a DNS server, and go to S607.

S607. The GW sends the DNS request to the DNS server to request the IP address corresponding to the hostname, for which the IP address fails to be found, in the URL.

The request information includes the hostname, for which the IP address fails to be found, in the URL.

In another embodiment of the present disclosure, S606.2 to S607 may be replaced with the following content: The GW acquires a hostname of a URL in a web page; the GW sends a DNS request to a DNS server to request an IP address corresponding to the hostname of the URL in the web page, where the request information includes the hostname of the URL in the web page; and after that, go to S608.

S608. The DNS server sends DNS response information to the GW.

The response information includes the hostname and the IP address corresponding to the hostname.

S609.1. The GW receives a DNS response packet, and parses a hostname and an IP address of the hostname in the DNS response packet.

S609.2. The GW acquires and stores the hostname and the IP address corresponding to the hostname.

S610.1. The GW replaces the hostname of the URL in the web page with the IP address corresponding to the hostname.

S610.2. The GW reconstructs an HTTP response packet.

The reconstructed HTTP response packet includes the web page packet that is obtained after the replacement.

S611. The GW sends the reconstructed HTTP response packet to the user equipment through an HTTP proxy.

S612. The user equipment requests access to network resources on a host corresponding to the IP address of the URL in the web page that is obtained after the replacement.

Therefore, based on technical solutions provided in this embodiment of the present disclosure, a hostname of a URL in a web page that is obtained after replacement has been replaced with an IP address, and when a user equipment requests access to the URL in the web page that is obtained after the replacement, the user equipment does not need to send a DNS request to a DNS server, and can directly access, according to the IP address, network resources on a host corresponding to the IP address, thereby reducing a web content transmission delay and optimizing web access.

FIG. 7 shows a signaling interworking diagram of another method for web access optimization according to an embodiment of the present disclosure. This embodiment of the present disclosure is a specific embodiment of embodiments of the present disclosure that are shown in FIG. 4 and FIG. 5. The method provided in this embodiment of the present disclosure may be executed by a web cache device, but the present disclosure is not limited thereto.

As shown in FIG. 7, the method for web access optimization provided in this embodiment of the present disclosure includes:

For S701 to S702, refer to S601 to S602 of the embodiment of the present disclosure shown in FIG. 6, and in the steps shown in FIG. 6, the steps executed by a GW may be executed by the web cache device in this embodiment of the present disclosure.

S703. Establish a TCP connection between a user equipment and the web caching device.

S704. The user equipment sends an HTTP request to the web cache device to request a web page.

S705. After receiving the HTTP request sent by the user equipment, the web cache device searches for, in a web cache, the web page requested by the user equipment. If the web page fails to be found, go to 706; otherwise, go to 710.2.

S706. Establish a TCP connection between the web cache device and a web server.

S707. The web cache device forwards the HTTP request of the user equipment to the web server.

S708. The web server sends HTTP response information to the web cache device.

S709. The web server disconnects the TCP connection.

S710.1. The web cache device receives the HTTP response information sent by the web server.

The web cache device acquires a web page included in the HTTP response information, and stores the web page in the web cache.

The S703 to S710.1 are steps of executing, by the web cache device, a function of caching a web page in this embodiment of the present disclosure.

Further, an existing device such as a fixed-line access gateway, a mobile gateway, a web cache device, a content optimization device, or an online compression device may execute a function of the existing device, and may further execute a technical solution provided in this embodiment of the present disclosure. That is, the technical solution provided in this embodiment of the present disclosure may overlap with a function of an existing device itself.

S710.2. The web cache device acquires a URL from the web page, and queries, in a local database according to a hostname of the URL, a hostname and IP address correspondence table.

S710.3. The web cache device replaces the hostname of the URL in the web page with a found IP address.

S710.4. The web cache device reconstructs an HTTP response packet.

The HTTP response packet includes the web page that is obtained after the replacement.

S715. The web cache device sends the HTTP response packet to the user equipment.

S716. The user equipment requests access to network resources on a host corresponding to the IP address of the URL in the web page that is obtained after the replacement.

Because the hostname of the URL in the web page that is obtained after the replacement has been replaced with the IP address, the user equipment does not need to send a DNS request to a DNS server to request to acquire the IP address corresponding to the hostname.

In a method for web access caching provided in this embodiment of the present disclosure, when the web cache device has a function of sending a DNS request to a DNS server, the web server may also send a DNS request to the DNS server when the web cache device fails to find, from a local database, the IP address corresponding to the hostname, so as to request the IP address that is corresponding to the hostname and fails to be found; after receiving a web page, the web cache device may also send a hostname in the web page to the DNS server to request an IP address corresponding to the hostname. Likewise, the method provided in this embodiment of the present disclosure may also be implemented by an existing fixed-line access gateway, a mobile gateway, a content optimization device, an online compression device, or the like.

Therefore, based on a method for content caching provided in this embodiment of the present disclosure, a hostname of a URL in a web page is replaced with an IP address by using a web cache device, and the web page that is obtained after the replacement is sent to a user equipment. When the user equipment requests network resources corresponding to the URLs in the web page, some hostnames of the URLs have been replaced with IP addresses. The user equipment does not need to send a DNS request to a DNS server, and can directly access, according to the IP addresses, network resources on hosts corresponding to the IP addresses, thereby reducing a web content transmission delay and optimizing web access.

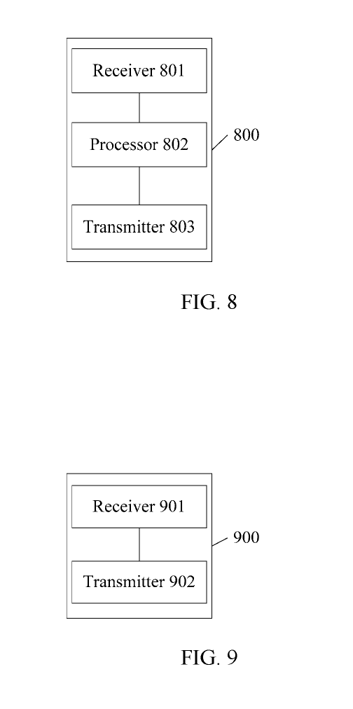

FIG. 8 shows a schematic block diagram of an apparatus 800 for web access optimization according to an embodiment of the present disclosure. This embodiment of the present disclosure may be executed by any proper apparatus, which is not limited in the present disclosure.

As shown in FIG. 8, the apparatus 800 for web access optimization provided in this embodiment of the present disclosure includes: a receiver 801, a processor 802, and a transmitter 803.

The receiver 801 is configured to receive a web page sent by a web server.

The web page includes a URL, that is, website address information. The apparatus acquires a hostname of the URL in the web page, so as to acquire, according to the hostname, an IP address corresponding to the hostname, where each hostname has a corresponding IP address.

The processor 802 is configured to acquire an Internet Protocol (IP) address corresponding to a hostname of a uniform resource locator (URL) in the web page, and replace the hostname of the URL in the web page with the IP address corresponding to the hostname.

The transmitter 803 is configured to send the web page that is obtained after the replacement to a user equipment, so that the user equipment accesses network resources on a host corresponding to the IP address of the URL in the web page that is obtained after the replacement.

Therefore, based on an apparatus provided in this embodiment of the present disclosure, an IP address corresponding to a hostname in a web page is queried and acquired, the hostname in the web page is replaced with a corresponding IP address, and the web page that is obtained after the replacement is sent to a user equipment. When the user equipment subsequently requests network resources corresponding to a URL in a received web page, because the hostname of the URL has been replaced with the IP address corresponding to the hostname, the user equipment does not need to initiate a query request to a DNS server, thereby reducing a web content transmission delay and optimizing web access.

In another embodiment of the present disclosure, that the processor 802 is configured to acquire an IP address corresponding to a hostname in the web page specifically includes that: the processor 802 is specifically configured to query, in a local database, the IP address corresponding to the hostname of the URL in the web page. The apparatus stores, in the local database, IP addresses corresponding to some hostnames. Therefore, the processor 802 in the apparatus may replace the hostnames of the URLs in the web page with the IP addresses that are corresponding to the hostnames and found from the local database. Because the hostnames of the URLs in the web page have been replaced with the IP addresses corresponding to the hostnames, when the user equipment requests again network resources corresponding to the hostnames, which are replaced, of the URLs in the web page, the user equipment does not need to send a DNS request to a DNS server, and can directly access, according to the IP addresses, network resources on hosts corresponding to the IP addresses, thereby reducing a web content transmission delay and optimizing web access.

In still another embodiment of the present disclosure, the apparatus further includes that: the transmitter 803 is further configured to, when the acquiring module fails to find an IP address corresponding to a hostname in the web page, send a DNS request to a DNS server, where the DNS request includes the hostname, which fails to be found, of the URL and is used to request the IP address that is corresponding to the hostname and fails to be found; and the receiver 801 is further configured to receive the hostname that fails to be found and sent by the DNS server, and the IP address corresponding to the hostname. Therefore, when the user equipment subsequently requests network resources of the hostname of the URL in the web page, the hostname of the URL in the web page has been completely replaced with the IP address corresponding to the hostname, and the user equipment does not need to send a DNS request to a DNS server to request to acquire the IP address corresponding to the hostname, thereby reducing a web content transmission delay and optimizing web access.

In still another embodiment of the present disclosure, the transmitter 803 is further configured to, before the receiver 801 acquires an IP address corresponding to a hostname of a URL in the web page, send a DNS request to a DNS server, where the DNS request includes the hostname of the URL and is used to request the IP address corresponding to the hostname; and the receiver 801 is configured to receive the IP address that is corresponding to the hostname of the URL in the web page and sent by the DNS server. The processor 802 replaces the hostname of the URL in the web page with the IP address corresponding to the hostname. Therefore, when the user equipment subsequently requests network resources of the hostname of the URL in the web page, the hostname of the URL in the web page has been completely replaced with the IP address corresponding to the hostname, and the user equipment does not need to send a DNS request to a DNS server, and can directly access, according to the IP address, network resources on a host corresponding to the IP address, thereby reducing a web content transmission delay and optimizing web access.

In still another embodiment of the present disclosure, the processor 801 is further configured to receive request information for requesting a web page sent by a user equipment; the processor 802 is further configured to acquire the request information; the transmitter 803 is further configured to send the request information for requesting the web page to a web server; and the receiver 801 is further configured to, after the transmitter 803 sends the request information to the web server, receive a web page sent by the web server; or the receiver 801 is configured to receive a web page pushed by the web server.

Operations and/or functions of each module in the apparatus that is provided in this embodiment of the present disclosure and shown in FIG. 8 are separately used to implement corresponding processes of each method in FIG. 4, FIG. 6, and FIG. 7; for brevity, details are not described herein again.

It should be understood that, an apparatus provided in an embodiment of the present disclosure may be a central processing unit (CPU), and may also be another general purpose processor, a digital signal processor (DSP), an application-specific integrated circuit (ASIC), a field-programmable gate array (FPGA), or another programmable logic device, a discrete gate or a transistor logic device, a discrete hardware component, or the like. A general purpose processor may be a microprocessor, or the processor may also be any conventional processor, or the like.

In an implementation process, the foregoing steps may be completed by using an integrated logic circuit of hardware in the apparatus provided in an embodiment of the present disclosure or an instruction in the form of software. Steps of the methods disclosed with reference to the embodiments of the present disclosure may be directly executed and accomplished by means of a hardware processor, or may be executed and accomplished by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory, and an apparatus provided by the embodiments of the present disclosure reads information in the memory and accomplishes the steps in the foregoing methods in combination with its hardware. To avoid repetition, details are not described herein again.

FIG. 9 shows a schematic block diagram of an apparatus 900 for web access optimization according to an embodiment of the present disclosure. The apparatus provided in this embodiment of the present disclosure may be any proper apparatus, for example, a user equipment.

As shown in FIG. 9, the apparatus 900 for web access optimization according to this embodiment of the present disclosure includes:

a receiver 901, configured to receive a web page sent by a network side, where the web page is a web page that is obtained after the network side replaces a hostname of a uniform resource locator (URL) in a web page received from a web server with an Internet Protocol (IP) address corresponding to the hostname; and

a transmitter 902, configured to send an access request for access to network resources on a host corresponding to the IP address of the URL in the web page after the replacement.

Therefore, based on an apparatus provided in this embodiment of the present disclosure, the apparatus receives a web page that is obtained after replacement. Because a hostname of a URL in the web page has been replaced with an IP address corresponding to the hostname, when the apparatus requests access to network resources corresponding to the URL, the apparatus does not need to send a DNS request to a DNS server, and can directly access, according to the IP address, network resources on a host corresponding to the IP address, thereby reducing a web content transmission delay and optimizing web access.

Operations and/or functions of each module in the apparatus that is provided in this embodiment of the present disclosure and shown in FIG. 9 are separately used to implement corresponding processes of each method in FIG. 5, FIG. 6, and FIG. 7; for brevity, details are not described herein again.

It should be understood that, an apparatus provided in an embodiment of the present disclosure may be a central processing unit (CPU), and may also be another general purpose processor, a digital signal processor (DSP), an application-specific integrated circuit (ASIC), a field-programmable gate array (FPGA), or another programmable logic device, a discrete gate or a transistor logic device, a discrete hardware component, or the like. A general purpose processor may be a microprocessor, or the processor may also be any conventional processor, or the like.

In an implementation process, the foregoing steps may be completed by using an integrated logic circuit of hardware in the apparatus provided in an embodiment of the present disclosure or an instruction in the form of software. Steps of the methods disclosed with reference to the embodiments of the present disclosure may be directly executed and accomplished by means of a hardware processor, or may be executed and accomplished by using a combination of hardware and software modules in the processor. The software module may be located in a mature storage medium in the field, such as a random access memory, a flash memory, a read-only memory, a programmable read-only memory, an electrically-erasable programmable memory, or a register. The storage medium is located in the memory, and an apparatus provided by the embodiments of the present disclosure reads information in the memory and accomplishes the steps in the foregoing methods in combination with its hardware. To avoid repetition, details are not described herein again.

It should be understood that, the term “and/or” in this embodiment of the present disclosure describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

A person of ordinary skill in the art may be aware that, in combination with the examples described in the embodiments disclosed in this specification, method steps and units may be implemented by electronic hardware, computer software, or a combination thereof. To clearly describe the interchangeability between the hardware and the software, the foregoing has generally described steps and compositions of each embodiment according to functions. Whether the functions are performed by hardware or software depends on particular applications and design constraint conditions of the technical solutions. A person of ordinary skill in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific embodiments of the present disclosure, but are not intended to limit the protection scope of the present disclosure. Any modification or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. An gateway device for Internet web access, comprising:
a processor; and
a memory storing instructions that, when executed by the processor, cause the gateway device to:
receive a web page sent by a web server;
acquire an Internet Protocol (IP) address corresponding to a hostname of a uniform resource locator (URL) in the web page;
replace the hostname of the URL in the web page with the IP address corresponding to the hostname; and
send the web page that is obtained after the replacement to a user equipment, so that the user equipment accesses network resources on a host corresponding to the IP address of the URL in the web page that is obtained after the replacement.

2. The gateway device according to claim 1, wherein acquiring the IP address comprises:
querying a database according to the hostname of the URL in the web page; and
acquiring, from the database, the IP address corresponding to the hostname of the URL in the web page.

3. The gateway device according to claim 2, wherein the instructions, when executed by the processor, further cause the gateway device to:
send a domain name system (DNS) request to a DNS server, wherein the DNS request comprises the hostname of the URL in the web page and is used to request the IP address corresponding to the hostname of the URL in the web page; and
receive the IP address that is corresponding to the hostname of the URL in the web page and sent by the DNS server; and
acquire the IP address that is corresponding to the hostname of the URL in the web page received from the web server.

4. The gateway device according to claim 1, wherein the instructions, when executed by the processor, further cause the gateway device to:
before acquiring the IP address corresponding to the hostname of the URL in the web page, send a domain name system (DNS) request to a DNS server, wherein the DNS request comprises the hostname of the URL in the web page and is used to request the IP address corresponding to the hostname;
receive the IP address that is corresponding to the hostname of the URL in the web page and sent by the DNS server; and
acquire the IP address that is corresponding to the hostname of the URL in the web page and received from the DNS server.

5. The gateway device according to claim 1, wherein the instructions, when executed by the processor, further cause the gateway device to:
receive request information for requesting a web page sent by the user equipment;
send the request information for requesting the web page to the web server; and
after sending the request information to the web server, receive the web page sent by the web server.

6. The gateway device according to claim 1, wherein the instructions, when executed by the processor, further cause the gateway device to:
receive a web page pushed by the web server.

7. An user equipment for Internet web access optimization, comprising:
a processor; and
a memory storing instructions that, when executed by the processor, cause the gateway device to:
receive a web page sent by a network side, wherein the web page is a web page that is obtained after the network side replaces a hostname of a uniform resource locator (URL) in a web page received from a web server with an Internet Protocol (IP) address corresponding to the hostname; and
send an access request for access to network resources on a host corresponding to the IP address of the URL in the web page after the replacement.

8. A method for Internet web access optimization, comprising:
receiving a web page sent by a web server;
acquiring an Internet Protocol (IP) address corresponding to a hostname of a uniform resource locator (URL) in the web page;
replacing the hostname of the URL in the web page with the IP address corresponding to the hostname; and
sending the web page that is obtained after the replacement to a user equipment, so that the user equipment accesses network resources on a host corresponding to the IP address of the URL in the web page that is obtained after the replacement.

9. The method according to claim 8, wherein the acquiring the IP address comprises:
querying a database according to the hostname of the URL in the web page; and
acquiring, from the database, the IP address corresponding to the hostname of the URL in the web page.

10. The method according to claim 9, further comprising:
sending a domain name system (DNS) request to a DNS server, wherein the DNS request comprises the hostname, for which the IP address fails to be found, in the URL and is used to request the IP address corresponding to the hostname of the URL in the web page; and
acquiring the IP address that is corresponding to the hostname of the URL in the web page and sent by the DNS server.

11. The method according to claim 8, wherein the acquiring an IP address corresponding to a hostname of a URL in the web page comprises:
sending a domain name system (DNS) request to a DNS server, wherein the DNS request comprises the hostname of the URL in the web page and is used to request the IP address corresponding to the hostname; and
acquiring the IP address that is corresponding to the hostname of the URL in the web page and sent by the DNS server.

12. The method according to claim 8, wherein the receiving the web page sent by the web server comprises:
receiving request information for requesting a web page sent by the user equipment;
sending the request information to the web server; and
receiving the web page sent by the web server.

13. The method according to claim 8, wherein the receiving the web page sent by the web server comprises:
receiving a web page pushed by the web server.

14. A method for web access optimization, comprising:
receiving, by a user equipment, a web page sent by a network side, wherein the web page is a web page that is obtained after the network side replaces a hostname of a uniform resource locator (URL) in a web page received from a web server with an Internet Protocol (IP) address corresponding to the hostname; and
accessing, by the user equipment, network resources on a host corresponding to the IP address of the URL in the web page that is obtained after the replacement.
